(19) United States
(12) Patent Application Publication
(10) Pub. No.: US 2021/0256464 A1
(43) Pub. Date: Aug. 19, 2021

(54) SYSTEM FOR GENERATING AND MAINTAINING UNIQUE IDENTIFIER DATA

(71) Applicant: SECOND THOUGHT OY, Lahti (FI)

(72) Inventors: Jani KASANEN, Lahti (FI); Jake LAISI, Lahti (FI)

(21) Appl. No.: 17/273,126

(22) PCT Filed: Sep. 3, 2019
(86) PCT No.: PCT/FI2019/050625

§ 371 Date: Mar. 3, 2021

(30) Foreign Application Priority Data
Sep. 4, 2018 (FI) 20185738

(51) Int. Cl. G06Q 10/08; G06F 16/22; G06F 16/245; G06Q 30/06; G06K 19/06

(52) U.S. Cl. CPC G06Q 10/087; G06F 16/2246; G06K 19/06009; G06Q 30/06; G06F 16/245

(57) ABSTRACT

According to an aspect, there is provided a method for generating unique identifiers by an identifier management system. First, the identifier management system receives from a terminal device via a communications network a first request for a unique identifier for a first set of one or more items of the same type. The first request comprises at least an identifier for the type of the first set and an expiration date for the first set. Then, the identifier management system generates a first unique identifier for the first set based at least on the identifier for the type of the first set, a first time stamp corresponding to a current time and the expiration date. The identifier management system stories the first unique identifier to a database 10 and transmits the first unique identifier for the first set to the terminal device via the communications network.

### FIELD OF THE INVENTION

The present invention relates to data management and more specifically to generating and managing unique identifiers for inventory management.

### BACKGROUND

The following background description art may include insights, discoveries, understandings or disclosures, or associations together with disclosures not known to the relevant art prior to the present invention but provided by the present disclosure. Some such contributions disclosed herein may be specifically pointed out below, whereas other such contributions encompassed by the present disclosure the invention will be apparent from their context.

Standardized identifiers such as EAN (European Article Number, also known as International Article Number) and UPC (Universal Product Code) are commonly used for identifying and tracking products or items, for example, for inventory management purposes. Each standardized identifier (EAN or UPC) typically contains information on the type of the associated item and is unique for that particular type of item. However, items of the same type typically share the same EAN or UPC. Therefore, identifiers for a particular item or product are not fully unique which limits the applications for which said identifiers may be used. For example, a first set of perishable goods (e.g., a particular sales batch) having a first expiration date cannot be distinguished from a second set of perishable goods of the same type (e.g., another sales patch) having a second, earlier expiration data just based on their EANs or UPCs. This limitation may often lead to additional food waste as the expiration date needs to be checked manually. Therefore, there is a need for a product identifier solution which would enable unique characterization of each individual item of a particular type.

### BRIEF DESCRIPTION OF THE INVENTION

The following presents a simplified summary of features disclosed herein to provide a basic understanding of some exemplary aspects of the invention. This summary is not an extensive overview of the invention. It is not intended to identify key/critical elements of the invention or to delineate the scope of the invention. Its sole purpose is to present some concepts disclosed herein in a simplified form as a prelude to a more detailed description.

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

Some embodiments provide methods, apparatuses and a computer program product for generating and managing unique identifiers.

### BRIEF DESCRIPTION OF THE DRAWINGS

In the following the invention will be described in greater detail by means of preferred embodiments with reference to the attached drawings, in which

FIG. 1 illustrates a system according to an embodiment;

FIG. 2 illustrates a database according to an embodiment;

FIGS. 3 to 6 illustrate processes according to embodiments;

FIGS. 7A and 7B illustrate examples of machine-readable optical codes generated by the identifier management system according to embodiments;

FIGS. 8 to 9 illustrate processes according to embodiments; and

FIG. 10 illustrates an apparatus according to some embodiments of the invention.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

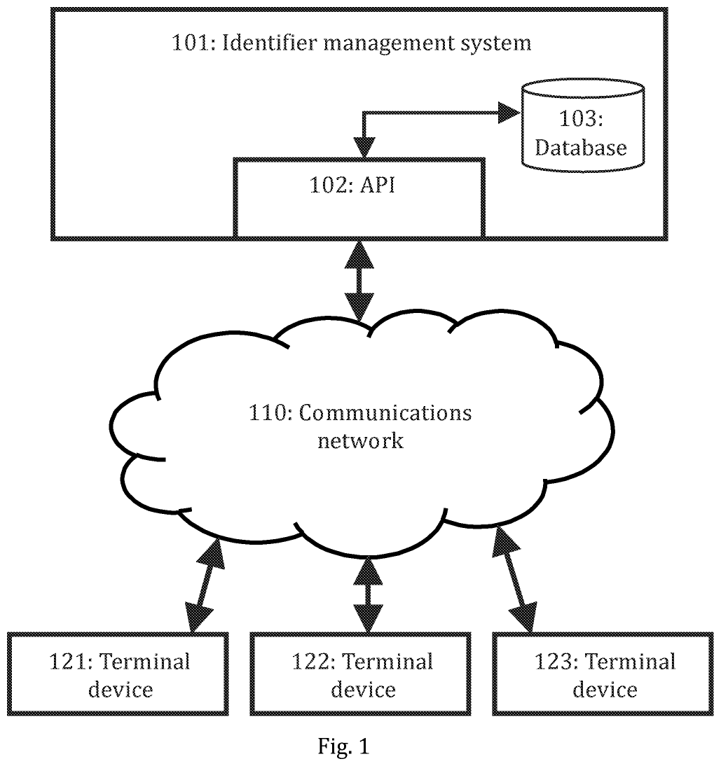

A very general architecture of a communications system to which embodiments of the invention may be applied is illustrated in FIG. 1. FIG. 1 illustrates a simplified system architecture only showing some elements and functional entities, all being logical units whose implementation may differ from what is shown. The connections shown in FIG. 1 are logical connections; the actual physical connections may be different. It is apparent to a person skilled in the art that the system also comprises other functions and structures.

FIG. 1 illustrates a communications system in which one or more terminal devices 121, 122, 123 are able to connect via a communications network 110 to a (remote) identifier management system 101. It should be appreciated that FIG. 1 presents a simplified version of a practical system and that in other embodiments, a very large number of terminal device may be connected to the (remote) identifier management system 101 via the communications network 110 or another communications network.

In some embodiments, the identifier management system 101 is a remote computing system or apparatus, that is, a computing system or apparatus not located in the vicinity of the one or more terminal devices 121, 122, 123 (at least not all of them). However, in other embodiments the identifier management system 101 may, alternatively, be a local computing system or apparatus, that is, a computing system or apparatus located in the vicinity of the one or more terminal devices 121, 122,123 (e.g., within the same building or room).

The communications network 110 may comprise one or more wireless networks, wherein a wireless network may be based on any mobile system, such as GSM, GPRS, LTE, 4G, 5G and beyond, and a wireless local area network, such as Wi-Fi. Furthermore, the communications network 110 may comprise one or more fixed networks and/or the internet. In some embodiments, the communications network 110 may consist of one or more individual wireless or wired telecommunications links between the local terminal devices 121, 122, 123 and the identifier management system 101. The terminal device 121, 122, 123 refers to a portable or non-portable computing device (equipment, apparatus) which is configured to access the identifier management system 101 via the communications network 110 and using a web-based application programming interface (API) 102 of the identifier management system 101. For example, the terminal device may be operated by a third party not directly affiliated with the identifier management system, but capable of requesting one or more services according to embodiments from the identifier management system 101. Computing devices (apparatuses) which may be employed include wireless mobile communication devices operating with or without a subscriber identification module (SIM) in hardware or in software, including, but not limited to, the following types of devices: desktop computer, laptop, touch screen computer, mobile phone, smart phone, personal digital assistant (PDA), handset, e-reading device, tablet, game console, note-book, multimedia device, sensor, actuator, video camera, car, wearable computer, telemetry appliances, telemonitoring appliances and any Internet of Things (IoT)-enabled devices. The terminal device may comprise or be connected to a server or a database. In general, any suitable technology that makes it possible to communicate with the identifier management system 101 via the communications network 110 (or via other means) may be utilized.

In some embodiments, at least one of the one or more terminal devices 121, 122, 123 may be a (IoT-enabled) reverse vending machines connected to the communications network 110 or a terminal device (e.g., as described in the previous paragraph) connected to the communications network 110 and configured to control a reverse vending machine. A reverse vending machine is a device that accepts used (empty) beverage containers and returns to the user a container deposit receipt which may be exchanged for cash, for example, by a cashier of a grocery store.

In some embodiments, one or more terminal devices may be operated by an administrator of the identifier management system 101. Such terminal devices may be able to fully access, configure and/or maintain the identifier management system 101.

The identifier management system 101 may be a server, a server system, a remote computing apparatus/system or a local computing apparatus/system. The identifier management system 101 may comprise a database or a database server 103 and optionally also one or more other network devices (not shown in FIG. 1), such as a terminal device, a server and/or a database. The identifier management system 101 may be cloud-based (e.g., a cloud server). The identifier management system 101 may comprise at least one web-based application programming interface through which the terminal devices 121, 122, 123 are able communicate with the identifier management system 101. The identifier management system 101 is configured at least to generate new unique identifiers upon requests from the terminal devices 121, 122, 123 and to transmit generated unique identifiers to the terminal devices 121, 122, 123. The database server 103 may maintain at least unique identifiers generated by the identifier management system 101. The database server 103 refers herein to a combination of a data storage (database) and a data management system. The data storage may be any kind of conventional or future data repository, including distributed and/or centralized storing of data, a cloud-based storage in a cloud environment, managed by any suitable data management system. The implementation of the data storage, the manner how data is stored, retrieved and updated are irrelevant to the invention, and therefore not described in detail here. Further, it should be appreciated that the location of the identifier management system 101 is irrelevant to the invention. The identifier management system 101 may be operated and maintained using one or more other network devices in the system or using one or more of terminal devices 121, 122, 123 via the communications network 103.

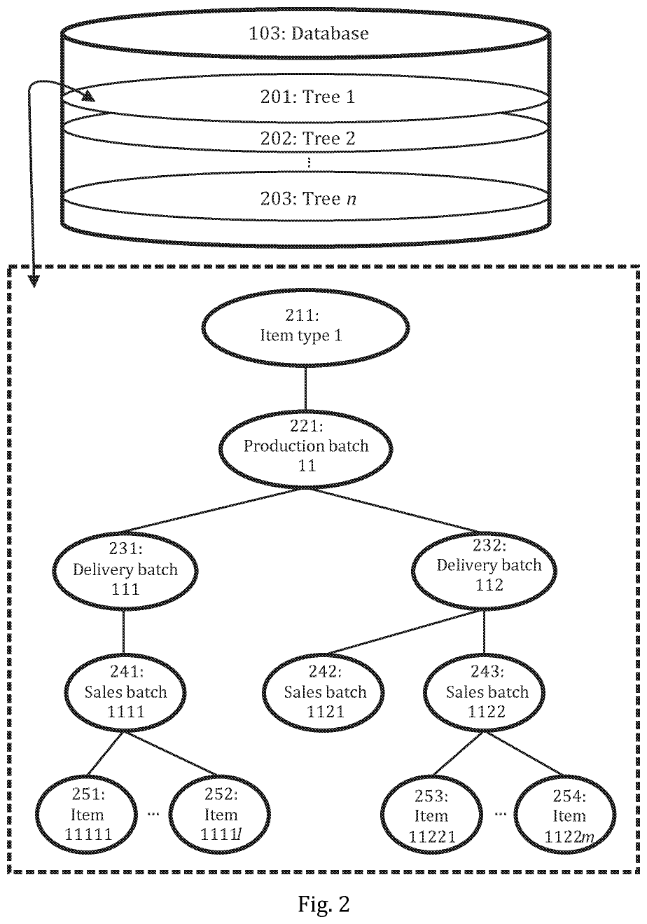

In some embodiments, the database server 103 maintains generated unique identifiers in one or more tree data structures. FIG. 2 illustrates an example of information stored in the database server 103 (or database) according to such an embodiment. In the illustrated example, the database 103 maintains n tree data structures 201, 202, 203. Each tree data structure corresponds to a different type of item (i.e., a different product). For example, tree data structure 1 may correspond to a 0.33 litre can of a particular cola-flavored carbonated soft drink, tree data structure 2 may correspond to a 0.5 litre bottle of the same cola-flavored carbonated soft drink, a tree data structure 3 may correspond to a 185 g can of tuna fish in oil from a particular manufacturer and so on. FIG. 2 further illustrates the tree data structure 1 (element 201) in detail as an example of the composition of a tree data structure according to an embodiment.

In general, a tree data structure is a data structure made up of nodes 211, 221, 231, 232, 241, 242, 243, 251, 252, 253, 254 (or vertices) and edges connecting said nodes without having any cycles. Each tree data structure is assumed to comprise at least a root node 211 (i.e., a top node of a tree). The information on the type of the item associated with a given tree data structure may be included in the root node 211 as this information is shared between all the individual items. The information on the type of the item may comprise at least a (numeric) identifier for the type of the item, for example, corresponding to any of the following standards describing a barcode symbology: EAN-8, EAN-13, UPC-A and UPC-E. The information on the type of the item may further comprise additional information on the type of the item such as manufacturer, country/place of origin (i.e., the country/place of manufacture, production or growth), sales price, product group (e.g., soft drink or umbrella), warranty and ingredients.

Each root node 211 may have one or more child nodes 221 which, in turn, may also have one or more child nodes 231, 232 and so on until a lowest level of the tree data structure is reached. In other words, one or more descendant nodes 221, 231, 232, 241, 242, 243, 251, 252, 253, 254 may be defined for each root node at one or more levels. Each descendant node defines one or more hierarchical sets of one or more items. A descendant node is defined as a node reachable by repeatedly proceeding from a parent node to a child node while the level of a node is des fined to be equal to the number of connections between the node and the root plus one. Each descendant node of each root node of each tree may comprise at least a unique identifier for a corresponding set of one or more items generated by the identifier management system according to an embodiment. Each descendant node may further comprise additional information unique to said node (i.e., unique for a certain set of items or for a particular individual item) such as an expiration date, information on supply chain, product history, anomalies in production or ingredients and/or country/place of origin (assuming that it is not shared with all the other nodes in tree data structure). Each descendant node may also comprise a (numeric) identifier (i.e., a non-unique identifier) for the type of that particular set of items. For example, if the identifier for the type of the item corresponds to an individual product (e.g., a particular chocolate bar), the identifier for a particular set of said items may correspond to an identifier for a pre-defined set of multiple individual products (e.g., a box comprising 18 chocolate bars). The identifiers for the type of the item and for the type of a particular set may have the same format. In some embodiments, said additional information may comprise warranty and maintenance history information. In some embodiments, each descendant node may also comprise the information on the type of the item (instead or in addition to it being included in the root node 211).

Referring to the exemplary detailed tree data structure 201 of FIG. 2, the tree data structure 201 has five levels. The root node 211 comprises a definition of the type of the item associated with the tree data structure 201. The largest set of items corresponds to a child node 221 of the root node 211. The node 211 correspond here to a production batch and may correspond to a very large number of individual items of the same type. The “production batch” node 221 has two child nodes 231, 232 which correspond to delivery batches. In other words, the production batch is divided, equally or unequally, into two delivery batches. The “delivery batch” nodes 231, 232 have one child node 241 and two child nodes 242, 243, respectively. These child nodes correspond to sales batches in the illustrated example. The “sales batch” node 241 has 1 child nodes 251, 252 each of which corresponds to an individual item. Similarly, the node 243 has m child nodes 253, 254 each of which also corresponds to an individual item. However, no child nodes are defined for the node 242 in the illustrated example. The individual items which are comprised in said sales batch may yet to have been added to the database in the illustrated scenario. In other embodiments, each leaf node (i.e., a node with no child nodes) in at least some of the one or more tree data structures 201, 202, 203 may always correspond to an individual item.

The tree data structure as illustrated using an example in FIG. 2 is ideally suited specifically for managing hierarchical data sets as exemplified above by the hierarchy “production batch”, “delivery batch”, “sales batch”, “production batch” and an individual item. However, a different data structure (e.g., a linked list or a bit array) to the tree data structure illustrated in FIG. 2 may be employed in some other embodiments. For example, in some cases only individual items may be defined in the database. In such a case, instead of the tree data structure a simpler data structure may be defined, for example, a data list.

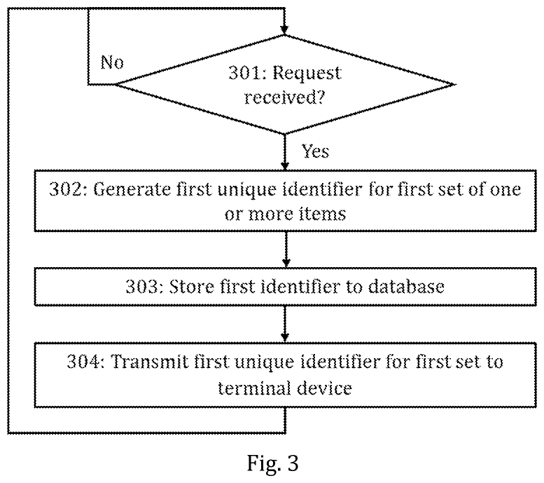

FIG. 3 illustrates a process according to an embodiment of the invention for handling a request for a new unique identifier. The process may be executed by a computing apparatus such as the identifier management system 101 of FIG. 1. It is assumed that at least one terminal device is connected via the communications network to the identifier management system, as illustrated in FIG. 1 for three terminal devices 121, 122, 123.

Referring to FIG. 3, the identifier management system receives, in block 301, from a terminal device via a communications network, a first request for a unique identifier for a first set of one or more items of the same type. The first request comprises information on the first set which, in turn, comprises at least an identifier for the type of the first set and an expiration date for the first set. The identifier for the type of the first set may be a numeric identifier. For example, the identifier may be one of EAN-8, EAN-13, UPC-A and UPC-E. The identifier management system generates, in block 302, a first unique identifier for the first set of one or more items based at least on the identifier for the type of the first set, a first time stamp corresponding to a current time and the expiration date. The first time stamp may be generated by the identifier management system for this purpose. Moreover, the first time stamp may specifically use the UNIX Epoch time system (preferably with one or more decimal digits, even more preferably with two or more decimal digits and most preferably with three or more decimal digits). The generated first unique identifier may be a numeric identifier and more specifically have a form compatible with GS1-128 standard. To ensure that the first unique identifier (and other unique identifiers generated by the identifier management system) are unique, the identifier management system may be configured not to use the same time stamp for multiple different unique identifiers. In other words, the time stamp may be used for achieving the uniqueness of the unique identifier. The identifier management system stores, in block 303, at least the first unique identifier to a database (e.g., the database 103 of FIG. 1 and/or FIG. 2). The identifier management system may also store at least some of the information on the first set of one or more items to the database. Finally, the identifier management system transmits, in block 304, the first unique identifier for the first set to the terminal device via the communications network. In some embodiments, the identifier management system may also transmit, in block 304, additional information relating to the first set and/or to one or more hierarchical sub- or supersets of the first set maintained in the database. As described in relation to FIG. 1 communication between terminal devices and the identifier management system may be provided by the communications network and a dedicated web-based application programming interface of the identifier management system.

The first set of one or more items may correspond to any item or product (e.g., an item of consumer goods or an item not available to consumers). In some embodiments, the first set may, in particular, correspond to an item or items of perishable goods or a perishable product or products. An item of perishable goods or a perishable product may be defined as an item or a product having a short life time or one that easily deteriorates. For example, such items may include fresh foods, dairy products, and pharmaceuticals. The short lifetime of these types of items complicates inventory management as they must be processed and moved through the supply chain for sale to customers before they perish. In such embodiments, the expiration date comprised in the received request may describe the anticipated shelf life for perishable goods. The expiration date may correspond to one of best before date, best by date, use by date, sell by date, display until date or any corresponding date indicating deteriorating of the quality of the item of perishable goods.

In some alternative embodiments, the information on the first set may not comprise the expiration date. Instead, the identifier management system may determine the expiration date based on the identifier for the type of the first set or based on other information comprised in the request (e.g., type of the item comprising the first set). For example, the first set may comprise nonperishable items (or a nonperishable item) for which no expiration date needs to be defined on grounds of health and safety or product quality, but an expiration date may be set for their validity. For example, the item may be a gift card, a voucher or a container deposit receipt. In these cases, the expiration date may, nevertheless, be included in the request or alternatively it may be set by the identifier management system (for example, as two weeks from the reception of the request or the generation of the corresponding unique identifier).

In some embodiments, the generating of the first unique identifier in block 302 may involve concatenating the numeric identifier for the type of the first set, the first time stamp and the expiration date (in a purely numeric format) in any order with or without a separator character separating concatenated parts. For example, the unique identifier may have the following form:

EAN-13 “-” time stamp “-” expiration date.

The EAN-13 is a 13-digit EAN standard used commonly in global trade. Here, “-” denotes a separator character which serves to separate the different parts of the unique identifier. In some embodiments, a different separator character or two or more different separator characters may be used or the separator characters may be omitted altogether. Specifically, the time stamp may be used for rendering the generated unique identifier unique. The identifier management system may be configured to generate unique identifiers so that the same time stamp is not shared by any two (or more) unique identifiers. The time stamp may be given in UNIX Epoch time system (also known as Unix time or POSIX time). The UNIX Epoch time system describes a point in time as the number of seconds that have elapsed since 00:00:00 Coordinated Universal Time (UTC), Thursday, 1 Jan. 1970. Every day is treated as if it contains exactly 86400 seconds. The time according to UNIX Epoch time system may be given with one or more decimal digits. In an embodiment, three decimal digits are used (that is, the time is given in milliseconds) which enables the generation of 1000 unique identifiers per second and thus ensures that the generated unique identifiers are truly unique and generated without delay even if a large number of requests are received almost simultaneously. In other embodiments, two or more decimal digits (corresponding to the accuracy of at least centiseconds and enabling generation of at least 100 unique identifiers per second) or three or more decimal digits may be used (corresponding to the accuracy of at least milliseconds and enabling generation of at least 1000 unique identifiers per second). The expiration date may be given in a number of numeric formats. In some embodiments, the expiration date may be given relative to the time stamp (or specifically relative to a UNIX Epoch time stamp with three decimal digits). For example, the expiration date may be defined with three digits according to the following notation system. The first digit denotes the unit of time so that “0” corresponds to hours, “1” corresponds to days, “2” corresponds to months and “3” corresponds to years. The following two digits denote the number of the units of time defined by the first digit till the expiration counted from the time of the time stamp. For example, “206” and “024” would correspond to expiration dates of six months and 24 hours counted from the time of the time stamp, respectively. The full unique identifier may be, for example, “1234567890123-1520407360335-048”, where 1234567890123 is the EAN-13, 1520407360335 is the UNIX Epoch time stamp (with three decimal digits, i.e., in milliseconds) corresponding to the date and time of Wednesday, 7 Mar. 2018, 07.22 and 048 is the expiration date relative to the UNIX Epoch time stamp. As is also evident from this example, no decimal separator is conventionally employed in the time stamps.

In some embodiments, a security number may be included in each unique identifier. In other words, the generating of the first unique identifier may involve concatenating the identifier for the type of the first set, the first time stamp, the expiration date and a first security number in any order with or without a separator character separating concatenated parts. The first security number may be generated based at least on the first time stamp (which may be defined using UNIX Epoch time as described above) and may consist of one or more digits (e.g., six digits). The full unique identifier with the security number at the end may be, for example, “1234567890123-1520407360335-048-123456”, where 1234567890123 is the EAN-13, 1520407360335 is the UNIX Epoch time stamp (with three decimal digits), 048 is the expiration date relative to the UNIX Epoch time stamp and 123456 is the security number with six digits.

In some alternative embodiments, EAN-8, UPC-A or UPC-E may be used in the concatenating as described in either of the two previous paragraphs instead of EAN-13.

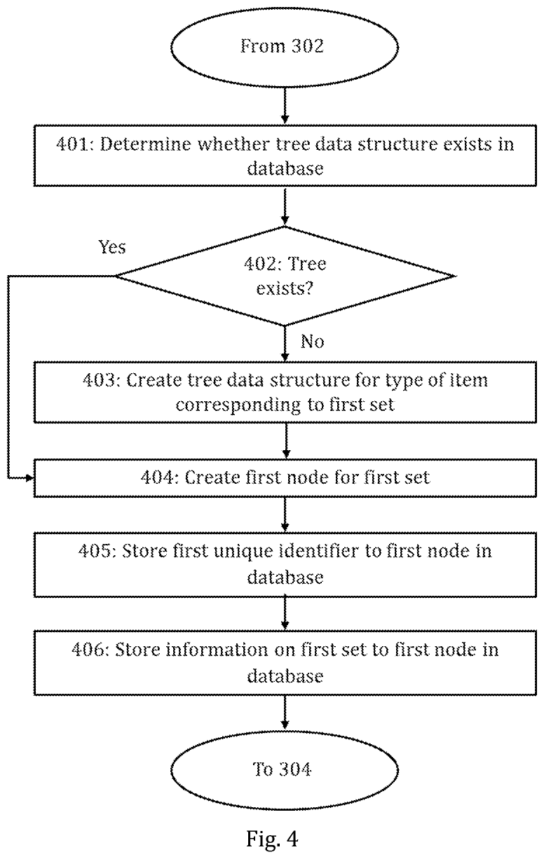

As discussed in relation to FIG. 2, the database may maintain one or more tree data structures. In such embodiments as well as in embodiments where no tree data structure yet exist but creation of tree data structures is enabled, the first unique identifier may be stored to a node of said one or more tree data structures. FIG. 4 illustrates a process for enabling the storing to a corresponding tree data structure according to an embodiment. The process of FIG. 4 may correspond to a more detailed implementation of block 303 of FIG. 3.

In FIG. 4, it is assumed that the information on the first set (received in the request) comprises information on any hierarchical sub- or supersets of the first set. For example, if the first set correspond to a single item, the information on the first set may comprise information on a sales batch (i.e., a superset) to which it belongs. To give another example, if the first set corresponds to a sales batch of items, the information on the first set may comprise information on the individual items forming the sales batch. Furthermore, the identifier management system may maintain, in the database, one or more tree data structures. Each tree data structure may correspond to a specific type of item. A root node of each tree data structure may define the type of the item and one or more descendant nodes of each root node at one or more levels may define one or more hierarchical sets of one or more items, where each descendant node of each root node of each tree comprises at least a unique identifier for a corresponding set of one or more items. Furthermore, the database may comprise at least one descendant node of a root node in a tree data structure maintained in the database comprises additional information on a corresponding set of one or more items, as discussed in relation to FIG. 2. In other embodiments, the database may not contain any tree data structures at the time of the process of FIG. 4.

Referring to FIG. 4, after the first unique identifier is generated, the identifier management system determines, in block 401, whether a (first) tree data structure for the type of item corresponding to the first set exists in the database based on the information on the first set. If no tree data structure exists in the database in block 402, the identifier management system creates, in block 403, a first tree data structure with a first root node based on the information on the first set. The identifier management system may store, when creating the first tree data structure, information on the item corresponding to the first set (e.g., information on the type of the item). Then, the identifier management system creates, in block 404, a first node corresponding to the first set to the first tree data structure. If a first tree data structure corresponding to the first set already exists in the database in block 402, the process proceeds directly to block 404. The identifier management system stores, in block 405, at least the first unique identifier to the first node of the first tree structure. Moreover, the identifier management system stores, in block 406, at least some of the information on the first set to the first node in the database as additional information on the first set. In some alternative embodiments, only the first unique identifier may be stored to the first node (i.e., block 405 may be omitted).

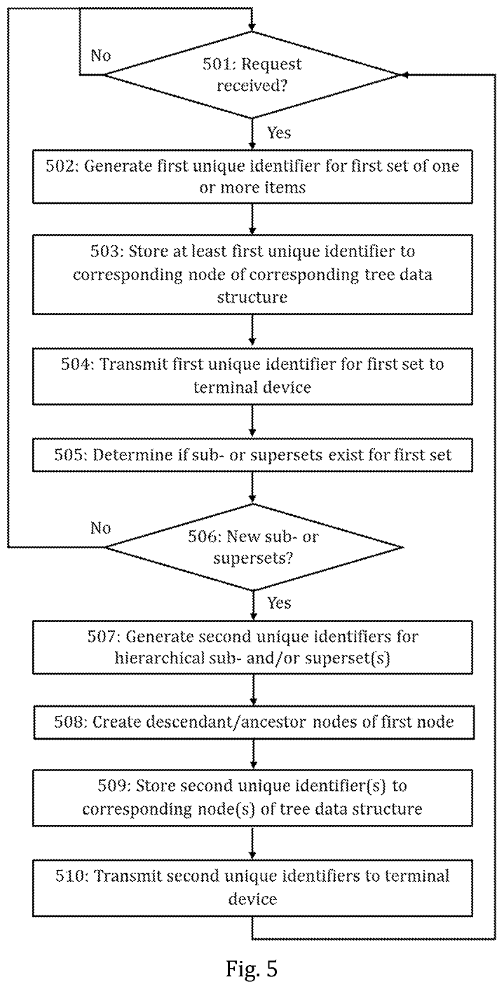

In the embodiments discussed in relation to FIGS. 3 and 4, the identifier management system generated, in response to the received request, a unique identifier for the first set of one or more items defined in the request, stored said unique identifier to the database and transmitted it to the terminal device which sent the request. If the first set corresponds, for example, to a sales batch of one or more items, the process of FIGS. 3 (and 4) leads to creating a unique identifier for the sales batch but not for the individual items comprising the sales batch. In some cases, it may be beneficial to create unique identifiers also for the individual items in the first set as a part of the same process (assuming that this has not yet been done and thus said unique identifiers are not available in the database). On the other hand, it may be that a delivery batch to which the aforementioned sales batch belongs has not been defined in the database. Therefore, it could also be beneficial in some cases if a superset of the first set could also be characterized in the same process. FIG. 5 illustrates a process providing means for realizing functionalities which solve the two aforementioned issues.

In FIG. 5, it is assumed that the information on the first set (as received in the request) may also comprise (non-unique) identifiers (and possibly other information) for any hierarchical sub- or supersets of the first set (i.e., an identifier identifying the type of the sub- or superset). For example, if the first set corresponds to a sales batch, the information on the first set may comprise a (nonunique) identifier (e.g., an EAN-8, an EAN-13, a UPC-A or a UPC-E code) for the individual items comprised in the sales batch. Blocks 501 to 504 may correspond to blocks 301 to 304 of FIG. 3 or blocks 301, 302 and 304 of FIG. 3 and FIG. 4. After the unique identifier for the first set has been created, stored to the database (to a first node of a first tree data structure) and transmitted to the first terminal device, the identifier management system determines, in block 505, whether the information on the first set comprises an identifier for at least one hierarchical subor superset of the first set not included in the first tree data structure as a node. Alternatively, the identifier management system may determine, in block 505, whether the information on the first set comprises an identifier for at least one hierarchical sub- or superset of the first set for which a unique identifier has not been defined and stored to the first tree data structure (a placeholder data node may exist in this case for the sub/superset). If the desired condition is true in block 506, the identifier management system performs for each hierarchical sub- or superset not included in the first tree data structure the following either in parallel or in sequence. First, the identifier management system generates, in block 507, for each new sub- or superset a second unique identifier based at least on an identifier for the type of the hierarchical sub- or superset, a second time stamp corresponding to a current time (which is different for each generation of a (first or second) unique identifier) and the expiration date. The generation of the second unique identifier may be performed similarly to the generation of the first unique identifier in any of the earlier embodiments though obviously the identifier and the (second) time stamp used in the generation are different. Each lowest hierarchical subset may correspond, here, to an individual item, that is, the identifier management system may generate also second unique identifiers for any individual items comprising the first set. The identifier for the type of each lowest hierarchical subset may be defined to be the identifier for the type of the item. While here it is assumed that all the new sub- and/or supersets correspond to the same expiration date (i.e., the one defined for the first set), this may not always be the case. In such a case, the larger set (e.g., a delivery batch) should be defined before the smaller set (e.g., a sales batch). Alternatively, the information on the first set received in the request may comprise information on the expiration dates of the supersets of the first set if they differ from the expiration date of the first set.

Then, the identifier management system creates, in block 508, based on the information on the first set for each second unique identifier corresponding to a subset a descendant node of the first node and/or for each second unique identifier corresponding to a superset an ancestor node of the first node. An ancestor node is a node reachable by repeated proceeding from child to parent (i.e., an opposite of a descendant node). The identifier management system stores, in block 509, at least the second unique identifier to a corresponding descendant or ancestor node of the first node. The identifier management system may further store any additional information available (e.g., in the request) to the corresponding descendant/ancestor nodes. Finally, the identifier management system transmits, in block 510, each second unique identifier to the terminal device via the communications network.

In some embodiments, data structures other than tree data structures may be employed, as mentioned above. While the discussion above in relation to FIG. 5 was (at least in part) specific to tree data structures, similar functionalities may be implemented also using other data structures. In the following, an exemplary, more general embodiment is described. In the more general embodiment, if the information on the first set comprises an identifier for one or more hierarchical sub- or supersets of the first set in block 506, the identifier management system may generate, in block 507, a second unique identifier for each sub- or superset (defined in the information on the first set) based at least on an identifier for the type of the hierarchical sub- or superset in question, a second time stamp corresponding to a current time and the expiration date (assumed here to be the same for the first set and for any of its sub- and/or supersets). However, thereafter the identifier management system may store each generated second unique identifier to the database and transmit each second unique identifier to the terminal device, as described in relation to block 510. In other words, actions pertaining to block 508 may be omitted and each second unique identifier may be stored to the database (not necessarily to any specific tree data structure in said database). In such more general embodiments, blocks 501 to 504 may be carried out as described in relation to blocks 301 to 304 of FIG. 3, respectively. Any of the functionalities described in relation to FIG. 3 and/or FIG. 5 may be combined with these (more general) embodiments.

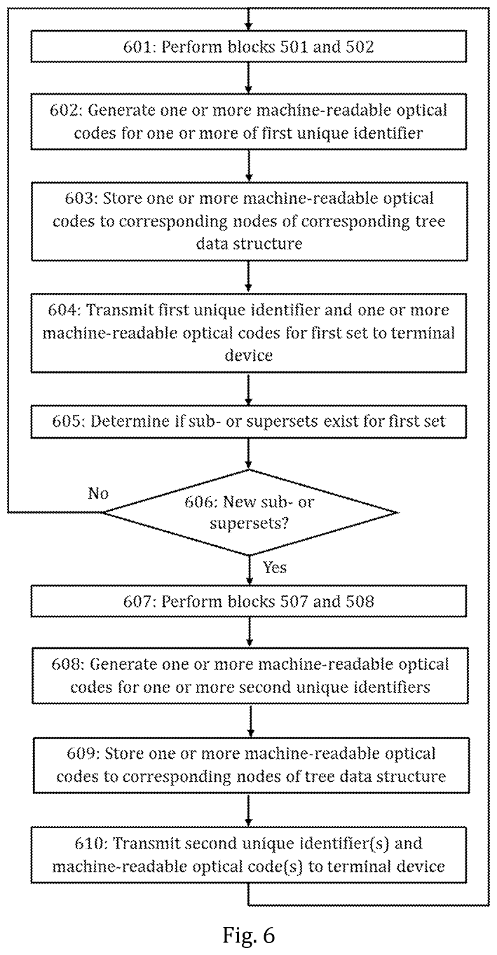

In addition to a unique identifier in a numeric format, the identifier management system may further be configured to provide the terminal device requesting the unique identifier one or more machine-readable optical codes (e.g., bar codes) corresponding to the unique (numerical) identifier. FIG. 6 illustrates a process carried out by the identifier management system according to an embodiment for providing said functionality.

Referring to FIG. 6, the identifier management system may, initially, perform, in block 601, actions as described in relation to blocks 501 and 502 of FIG. 5. Thereafter, the identifier management system generates, in block 602, one or more first machine-readable optical codes for the first unique identifier. In other words, each first machine-readable optical code may be generated based directly on the numeric format of the first unique identifier according to any embodiments described in relation to FIG. 3. The one or more first machine-readable optical codes may comprise one or more of a GS1-128 bar code (formerly known as an UCC/EAN-128 bar code) and a Quick Response, QR, code. In other words, the one or more first machine-readable optical codes may comprise at least one machine-readable optical code which may be read by conventional barcode scanners and/or optical readers without requiring any modifications to the barcode scanner or optical reader is itself. The identifier management system stores, in block 603, the one or more first machine-readable optical codes to the first node in the database and transmits, in block 604, information on each first machine-readable optical code (e.g., an image file corresponding to each first machine-readable optical code) along with the first unique identifier to the terminal device via the communications network.

A similar process as was described for the first set may be carried out for each sub- or superset of the first set for which a second unique identifier is generated. After it is determined in blocks 605 and 606 that the information on the first set comprises an identifier for at least one hierarchical sub- or superset of the first set not included in the first tree data structure as a node, the second unique identifier(s) may be generated and corresponding nodes created in block 607 corresponding blocks 507 and 508 of FIG. 5. Then, the identifier management system generates, in block 608, one or more second machine-readable optical codes for one or more of the one or more second unique identifiers. The one or more secand machine-readable optical codes may have the same format as the one or more first machine-readable optical codes. The identifier management system stores, in block 609, the one or more machine-readable optical codes to the database (i.e., to corresponding nodes of tree data structure) and transmits, in block 610, information on each second machine-readable optical code along with a corresponding second unique identifier to the terminal device via the communications network.

After the process of FIG. 6, the user of the first terminal device (e.g., a retailer) may print out each first/second machine-readable optical code and attach it to the corresponding product or item or set of products or items. Subsequently, the first machine-readable optical codes may be read optically (e.g., upon purchase of the product) to facilitate inventory management. Alternatively, the first terminal device may be configured to automatically print out the one or more first machine-readable optical code.

As a special case of the latter alternative and as mentioned also in relation to FIG. 1, the first terminal device may be a reverse vending machine connected to the communications network (i.e., an IoT-enabled reverse vending machine) and capable of printing container deposit receipts (and/or other deposit receipts). Alternatively, the first terminal device may be a terminal device connected to the communications network 110 and configured to control a reverse vending machine which is capable of printing container deposit receipts. Such a reverse vending machine (or a terminal device controlling the reverse vending machine) may be configured to request a unique identifier from the identifier management system when the user of the reverse vending machine indicates (e.g., by a button press or other user input) that he/she has returned all his/her containers. Further, the reverse vending machine or the terminal device controlling the reverse vending machine may be configured to, in response to receiving the first unique identifier and the one or more first machine-readable optical codes, include at least one of the one or more first machine-readable optical codes in the container deposit receipt that it prints out for the user returning the containers. In such embodiments, the one or more tree data structures maintained in the database may comprise or consist of a two-level tree data structure corresponding to container des posit receipts or a simpler data structure (e.g., a data list). Moreover, the first set as discussed in relation to any of the above embodiments may consist of a single item corresponding to a first container deposit receipt (which may be printed out only after the first unique identifier is generated). The expiration date may be defined in these embodiments by the IoT-enabled reverse vending machine or the terminal device controlling a reverse vending machine (in the request) or the identifier management system (after receiving the request), for example, to correspond to a predefined amount of time (e.g., two months) after the date of the generation of the unique identifier. In some embodiments, the request transmitted by the IoT-enabled reverse vending machine or the terminal device controlling a reverse vending machine may include as additional information, for example, information on the total sum of the container deposit receipt and/or the number of items (of one or more different types) returned using the reverse vending machine and their monetary values.

In some embodiments, the machine-readable optical codes may not be stored to the database but only generated and consequently transmitted to the corresponding terminal device.

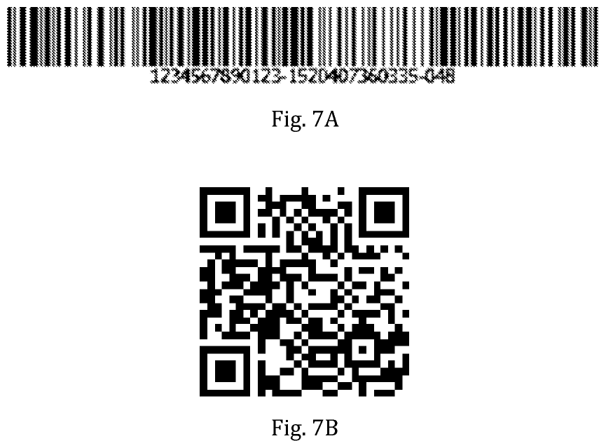

FIGS. 7A and 7B illustrate two examples of machine-readable optical codes generated by the identifier management system according to an embodiment. Specifically, FIG. 7A illustrate a GS1-128 bar code and FIG. 7B illustrates a QR code. Both FIGS. 7A and 7B correspond to the same aforementioned exemplary unique identifier given in the numeric format as “1234567890123-1520407360335-048”.

In some embodiments, instead of using machine-readable optical codes the user of the first terminal device (e.g., a retailer) may configure a Radio Frequency Identification (RFID) chip or a Near-Field Communication (NFC) chip to maintain the first unique identifier in a memory of the RFID or NFC chip (or tag), respectively. The RFID/NFC chip may be attached to the item(s) in question. By reading the RFID/NFC chip with a RFID/NFC-enabled (portable) device, the unique identifier may be extracted. In some embodiments, the memory of the RFID/NFC chip may also comprise additional information on the first set of one or more items as described in relation to FIG. 2 (e.g., information on manufacturer, country/place of origin, sales price, product group, warranty and/or ingredients). Further, the memory of the RFID/NFC chip may comprise information on unique identifiers of the individual items or subsets of items assuming that the first set comprises multiple items and/or subsets.

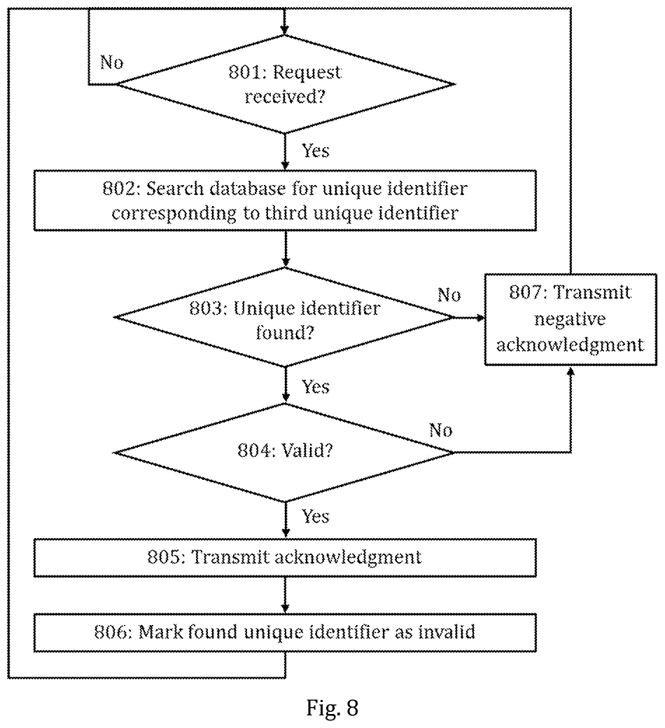

In some instances, it may be beneficial for a user using the services provided by the identifier management system via a terminal device to be able to know whether a particular item is still valid, that is, whether it has been purchased by a consumer or whether a voucher or a container deposit receipt has already been used (i.e., exchanged for cash). The former case may be relevant, for example, when there is a product recall of a particular sales batch due to a dangerous product defect being detected (e.g., sharp shards of metal detected found in a food product). The latter case is relevant in preventing exchange of forged or already used container deposit receipts to cash. FIG. 8 illustrates a process carried out by the identifier management system for implementing an invalidation process according to an embodiment. The invalidation process may be carried out, for example, upon a purchase of an item or use of an item (e.g., a container deposit receipt).

In FIG. 8, it is assumed that the database comprise one or more tree data structures as discussed, for example, in relation to FIG. 2 and FIG. 4. Furthermore, it is assumed that each node of each tree data structure in the database may be associated with information on validity of a unique identifier stored in said node. In addition to the basic “valid/invalid” information, the information on validity may comprise, for example, time information indicating when the item or a set of items was marked as invalid (i.e., when it was purchased or used).

The process of FIG. 8 is initiated by the identifier management system receiving, in block 801, from a second terminal device via the communications network a third request for invalidating a third unique identifier comprised in the third request. The second terminal device may or may not be the same as the previously mentioned first terminal device. The identifier management system searches, in block 802, the database for a unique identifier matching the third unique identifier (or for a node comprising said unique identifier). If the third unique identifier is found in block 803 from the database and further if the third unique identifier is marked as valid in the database in block 804, the identifier management system transmits, in block 805, an acknowledgement to the second terminal device and marks, in block 806, the third unique identifier in the corresponding node of the database as invalid. The identifier management system may store further information regarding validity to the corresponding node (e.g., time information as discussed above). If the third unique identifier is not found from the database in block 803 or if it is denoted as invalid in the database in block 804, the identifier management system transmits, in block 807, a negative acknowledgement to the second terminal device.

In embodiments where the third request is transmitted upon a purchase of a product, the negative acknowledgment may tell the user of the second terminal device simply that an error of some kind has occurred in the inventory management leading to multiple products being labeled with the same machine-readable optical codes. On the other hand, in embodiments where the third request is transmitted upon a completion of container recycling/deposit process using a reverse vending machine, the negative acknowledgment may indicate to the person in charge of handling the container deposit receipts (e.g., cashier of a grocery store) that the person who provided the container deposit receipt may be trying to commit a crime by reusing a container deposit receipt or using a forged container deposit receipt. In these embodiments, the third unique identifier may correspond to a second container deposit receipt.

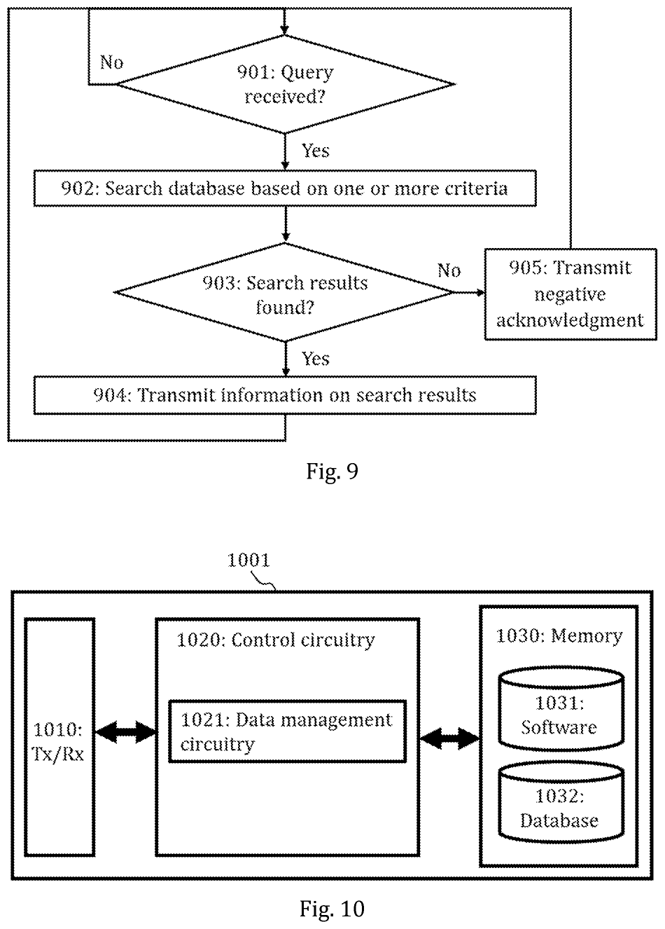

As described in relation to previous embodiments and in particular to FIG. 2, the database of the identifier management system may maintain information in the form of tree data structures (or other data structures) on a number of different types of items and further on each individual item and set of items of a particular type. Additional information (that is, in addition to the unique identifiers) may be stored to the database (or specifically to corresponding nodes of tree data structures) at least for some of the individual items and/or sets of items. This information may not be directly extractable from the unique identifiers. However, the users of the terminal devices may be able transmit search requests or queries to the identifier management system which may be configured handle said requests or queries and transmit the search results back to the terminal device in question. FIG. 9 illustrates an exemplary process to be carried out by the identifier management system for realizing said functionality.

In FIG. 9, the identifier management system, first, receives, in block 901, a search query for finding items matching one or more (search) criteria from a third terminal device (which may be the same as the first and/or second terminal device) via the communications network. The one or more criteria may relate to any information stored to the database (i.e., to the nodes of the database). For example, the one or more criteria may relate to one or more of the following: unique identifier corresponding a set of items or an individual item, the type of the item, expiration date, expiration date range, country of origin, production batch, sales batch, delivery batch and product group. In some embodiments, the search query may be transmitted from a terminal device of a user in response to the user scanning a machine-readable optical code of the item (the search criterion being in this case the scanned unique identifier). Upon receiving the search query, the identifier management system searches, in block 902, the database for items matching the one or more criteria. In response to finding one or more items and/or one or more sets of items matching the one or more criteria in block 903, the identifier management system transmits, in block 904, information on the one or more items and/or the one or more sets of items matching the one or more criteria to the third terminal device. In some embodiments, only some of the information on the one or more items and/or the one or more sets of items maintained on the database may be transmitted to the third terminal device based on the search query or the configuration of the identifier management system. In response to failing to find any items matching the one or more criteria in block 903, the identifier management system transmits, in block 905, a negative acknowledgement to the third terminal device.

The unique identifiers and the identifier management system for generating and maintaining them as described in relation to any of the embodiments may find applications in a variety of sectors. One significant potential application lies in the food industry. The identifier management system and the unique identifiers generated by it according to embodiments provide means for tracking a variety of different properties of individual products such as country of origin, production and delivery batch and the expiration date. Especially facilitation of automatic tracking of the expiration dates of products may be hugely beneficial for the individual stores or chains of store as well as for wholesale dealers as currently it is often common practice to check the expiration dates of individual products manually. This type of manual checking of expiration dates may lead to human error or the checking of expiration date may be neglected to due to lack of resources which may lead to additional food waste and/or sale and subsequent consumption of expired goods.

Another benefit of the digital monitoring enabled by the unique identifiers and the identifier management system according to embodiments relates to product recalls, i.e., the removal of defective products from market. In the present systems, a product defect or a safety issue results in the whole production batch being pulled from market. Further, leaflets or paid notices in newspapers may distributed to inform consumers of defective or even dangerous products. With the unique identifier and the identifier management system maintaining the database of product information according to embodiments, the consumer is able to check by themselves by scanning the machine-readable optical unique identifier or typing in the numeric unique identifier whether their product is associated with warnings or recalls (corresponding to the process of FIG. 9). This way people suffering from severe food allergies may also be able to check the safety of a product before they consume it. Furthermore, if the consumer belongs to a loyalty program, the identifier management system may be configured to associate the consumer with the purchased products, according to some embodiments. Consequently, the customer may be individually informed by the identifier management system if he or she is in possession of defective or dangerous products.

To give another exemplary application for the unique identifiers and the identifier management system, the identifier management system may maintain information specifically on durable goods (e.g., cars and home appliances) which may have been already purchased. In said embodiments, the database may comprise as additional information on each item warranty and maintenance history information. The warranty and maintenance history information may comprise, for example, information on one or more of warranty, dates of maintenance, what kind of maintenance was performed and/or who provided the maintenance. By carrying out the process of FIG. 9 using the unique identifier of the product as a search criterion, a user of a terminal device may access said information or at least some of said information. Said user may correspond to the owner or potential new owner of the item in question, a maintenance provider (e.g., a repair shop) or a manufacturer. The personal information may not be stored to the database and/or may not be available (at least not in full) to the user. In some embodiments, said personal information may be rendered visible upon a request by the person in question. In any of the embodiments discussed in this paragraph, the expiration date may correspond to, e.g., expiration date of the warranty.

In some embodiments, the unique identifier may be used to improve security in connection to a resale of a product such as an admission ticket. A ticket vendor may use the identifier management system for assigning unique identifiers to tickets when the ticket is sold. The request for generating the unique identifier may comprise also information on the person purchasing the ticket (or the owner of the ticket) which may be stored to the database as additional information on said item. The machine-readable optical code may be generated by the identifier management system according to embodiments (i.e., process of FIG. 6) and it may act as the sole machine-readable optical identifier for the ticket. Each ticket vendor may choose to allow resales of tickets (or at least certain tickets) in the identifier management system. In the case of a resale of the ticket, the person buying the ticket may be able to check by themselves by scanning the machine-readable optical unique identifier or typing in the numeric unique identifier whether the ticket is legitimate and/or that the reseller is the true owner of the ticket (corresponding to the process of FIG. 9). During the resale transaction, the reseller may be able to change the owner information for the ticket stored to the database by transmitting a request from a terminal device to the identifier management system.

The blocks, related functions, and information exchanges described above by means of FIGS. 2 to 6, 8 and 9 are in no absolute chronological order, and some of them may be performed simultaneously or in an order differing from the given one. Other functions can also be executed between the blocks and related functions or within them, and other information may be sent. Some of the blocks or part of the blocks or one or more pieces of information can also be left out or replaced by a corresponding block or part of the block or one or more pieces of information.

FIG. 10 illustrates an apparatus 1001 configured to carry out the functions or some of the functions described above in connection with the identifier management system 101 illustrated in FIG. 1. The apparatus 1001 may be an electronic device comprising electronic circuitries. The apparatus 1001 may be a separate (network) entity or a plurality of separate entities. The apparatus 1001 may comprise or be connected to a database or a database server 103 and/or comprise a web-based application programming interface 102. The apparatus 1001 may comprise a control circuitry 1020 such as at least one processor, and at least one memory 1032 including a computer program code (software) 1031 wherein the at least one memory and the computer program code (software) are configured, with the at least one processor, to cause the apparatus 1001 to carry out any one of the embodiments of the invention described above.

The control circuitry 1020 of the terminal device 1401 comprise at least data management circuitry 1021 which is configured to perform generation and management of unique identifiers. To this end, the data management circuitry 1021 is configured to carry out functionalities described above by means of any of FIGS. 1 to 6, 7A, 7B, 8 and 9 using one or more individual circuitries.

The memory 1004 may be implemented using any suitable data storage technology, such as semiconductor-based memory devices, flash memory, magnetic memory devices and systems, optical memory devices and systems, fixed memory and removable memory. The memory may comprise a database 1032 which may be or comprise the data warehouse 104 of FIG. 1 or it may a separate database from the data warehouse 104. The memory 1030 may be connected to the control circuitry 1020 via an interface.

The apparatus 1001 may further comprise a communication interface (Tx/Rx) 1010 comprising hardware and/or software for realizing communication connectivity according to one or more communication protocols. The communication interface 1010 may comprise at least one (web-based) application programming interface. The communication interface 1010 may comprise standard wellknown components such as an amplifier, filter, frequency-converter, (de)modulator, and encoder/decoder circuitries and one or more antennas.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

A computer a program (or at least one portion of computer program) comprising program code means adapted to perform any necessary steps, when the computer program (or the at least one portion of computer program) is run on a processor can implement the invention and its embodiments as discussed in relation FIGS. 1 to 6, 7A, 7B, 8 and 9. Also different kind of mapping procedures and transmitting of information are possible using one or more computer programs. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

All modifications and configurations required for implementing functionality of the embodiments may be performed as routines, which may be implemented as added or updated software routines, application specific integrated circuits (ASIC) and/or programmable circuits. Software routines, also called program products, including applets and macros, can be stored in any apparatus-readable data storage medium and they include program instructions to perform particular tasks. Software routines may be downloaded into an apparatus. The apparatus, such as controllers, or corresponding server components, or a user terminal may be configured as a computer including at least a memory for providing storage area used for arithmetic operation and an operation processor for executing the arithmetic operation. An example of the operation processor includes a central processing unit. The memory may be removable memory detachably connected to the apparatus or to information system.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

It will be obvious to a person skilled in the art that, as the technology advances, the inventive concept can be implemented in various ways. The invention and its embodiments are not limited to the examples described above but may vary within the scope of the claims.

1. A method comprising:
receiving, in an identifier management system from a terminal device via a communications network, a first request for a unique identifier for a first set of one or more items of the same type, wherein the first request comprises information on the first set, the information on the first set comprising at least an identifier for the type of the first set and an expiration date for the first set;
generating, by the identifier management system, a first unique identifier for the first set of one or more items based at least on the identifier for the type of the first set, a first time stamp corresponding to a current time and the expiration date;
storing, by the identifier management system, the first unique identifier to a database; and
transmitting, by the identifier management system, the first unique identifier for the first set to the terminal device via the communications network.

2. The method of claim 1, the method comprising:
concatenating, in the generating of the first unique identifier, the identifier for the type of the first set, the first time stamp and the expiration date in any order with or without a separator character separating concatenated parts, wherein the identifier for the type of the first set is a numeric identifier, the first time stamp uses the UNIX Epoch time system and the expiration date is given relative to the first time stamp; or
concatenating, in the generating of the first unique identifier, the identifier for the type of the first set, the first time stamp, the expiration date and a first security number in any order with or without a separator character separating concatenated parts, wherein the identifier for the type of the first set is a numeric identifier, the first time stamp uses the UNIX Epoch time system, the expiration date is given relative to the first time stamp and the first security number is generated based at least on the first time stamp.

3. The method of claim 1, wherein the first time stamp uses the UNIX Epoch time system with three or more decimal digits.

4. The method of claim 1, the method comprising:
generating, by the identifier management system, one or more first machine-readable optical codes for the first unique identifier;
storing, by the identifier management system, the one or more first machine-readable optical codes to the database; and
transmitting, by the identifier management system, information on each first machine-readable optical code along with the first unique identifier to the terminal device via the communications network.

5. The method of claim 1, wherein the information on the first set comprises an identifier for at least one hierarchical sub- or superset of the first set, the method further comprising performing for each hierarchical sub- or supersets of the first set:
generating, by the identifier management system, a second unique identifier based at least on an identifier for the type of the hierarchical sub- or superset, a second time stamp corresponding to a current time and the expiration date;
storing, by the identifier management system, the second unique identifier to the database; and
transmitting, by the identifier management system, the second unique identifier to the terminal device via the communications network.

6. The method of claim 1, wherein the information on the first set comprises information on any hierarchical sub- or supersets of the first set, the method further comprising:
maintaining, in the database, one or more tree data structures, each tree data structure corresponding to a specific type of item, a root node of each tree data structure defining the type of the item and one or more descendant nodes of each root node at one or more levels defining one or more hierarchical sets of one or more items, wherein each descendant node of each root node of each tree comprises at least a unique identifier for a corresponding set of one or more items;
determining, by the identifier management system, before the storing whether a tree data structure for the type of item corresponding to the first set exists in the database;
in response to a first tree data structure for the type of item corresponding to the first set exists in the database, creating, in the storing of the first unique identifier, a first node to the first tree data structure corresponding to the first set based on the information on the first set, wherein at least the first unique identifier is stored to the first node; and
in response to no tree data structure for the type of item corresponding to the first set exists in the database, creating, in the storing of the first unique identifier, a first tree data structure with a first root node and a first node corresponding to the first set based on the information on the first set, wherein at least the first unique identifier is stored to the first node.

7. The method of claim 6, the method further comprising:
storing, by the identifier management system, at least some of the information on the first set to the first node in the database as additional information on the first set.

8. The method of claim 6, the method further comprising, when the information on the first set comprises an identifier for at least one hierarchical sub- or superset of the first set not included in the first tree data structure as a node, performing for each hierarchical sub- or superset not included in the first tree data structure the following:
generating, by the identifier management system, a second unique identifier based at least on the identifier for the type of the hierarchical sub- or superset, a second time stamp corresponding to a current time and the expiration date, each lowest hierarchical subset corresponding to an individual item and the identifier for the type of each lowest hierarchical subset being the identifier for the type of the item corresponding to the first set;
creating, by the identifier management system, based on the information on the first set for the second unique identifier corresponding to a subset a descendant node of the first node or for the second unique identifier corresponding to a superset an ancestor node of the first node;
storing, by the identifier management system, the second unique identifier to a corresponding descendant or ancestor node of the first node; and
transmitting, by the identifier management system, the second unique identifier to the terminal device via the communications network.

9. The method of claim 8, further comprising performing, if the information on the first set comprises the identifier for at least one hierarchical sub- or superset of the first set not included in the first tree data structure as a node, the following:
concatenating, in the generating of each second unique identifier, the identifier for the type of a corresponding hierarchical sub- or superset, the second time stamp and the expiration date in any order with or without the separator character separating concatenated parts, wherein the identifier for the type of the corresponding hierarchical sub- or superset is a numeric identifier, the second time stamp uses the UNIX Epoch time system and the expiration date is given relative to the second time stamp; or
concatenating, in the generating of each second unique identifier, the identifier for the type of a corresponding hierarchical sub- or superset, the second time stamp, the expiration date and a second security number in any order with or without the separator character separating concatenated parts, wherein the identifier for the type of a corresponding hierarchical sub- or superset is numerical identifier, the second time stamp uses the UNIX Epoch time system the expiration date is given relative to the second time stamp and the second security number is generated based at least on the second time stamp.

10. The method of claim 8, further comprising performing, if the information on the first set comprises the identifier for at least one hierarchical sub- or superset of the first set not included in the first tree data structure as a node, the following:
generating, by the identifier management system, one or more second machine-readable optical codes for one or more of the one or more second unique identifiers;
storing, by the identifier management system, the one or more second machine-readable optical codes to corresponding one or more descendant or ancestor nodes; and
transmitting, by the identifier management system, information on each second machine-readable optical code along with a corresponding second unique identifier to the terminal device via the communications network.

11. The method of claim 4, wherein each machine-readable optical code is one of a GS1-128 bar code and a Quick Response, QR, code.

12. The method of claim 6, wherein each node of each tree data structure is associated with information on validity of a unique identifier stored in the node, the method further comprising, in response to receiving, in the identifier management system from a second terminal device via the communications network, a third request for invalidating a third unique identifier comprised in the third request, performing the following:
searching, by the identifier management system, the database for a unique identifier denoted as valid corresponding to the third unique identifier;
in response to finding the third unique identifier being denoted as valid from the database, transmitting an acknowledgement to the second terminal device and marking the third unique identifier in the database as invalid; and
in response to failing to find the third unique identifier from the database or finding the third unique identifier denoted as invalid from the database, transmitting a negative acknowledgement to the second terminal device.

13. The method of claim 12, wherein the one or more tree data structures comprise a two-level tree data structure corresponding to container deposit receipts, the first set consisting of a single item corresponding to a first container deposit receipt and/or the third unique identifier corresponds to a second container deposit receipt, the first terminal device being an Internet of Things, IoT, -enabled reverse vending machine connected to the communications network or a terminal device connected to the communications network and configured to control a reverse vending machine.

14. The method of claim 6, further comprising, in response to receiving, in the identifier management system from a third terminal device via the communications network, a search query for finding items matching one or more criteria, performing the following:
searching, by the identifier management system, the database for items matching the one or more criteria;
in response to finding one or more items matching the one or more criteria, transmitting information on the one or more items matching the one or more criteria to the third terminal device; and
in response to failing to find any items matching the one or more criteria, transmitting a negative acknowledgement to the third terminal device.

15. The method of claim 1, wherein each numeric identifier for the type of a set of items or for the type of an item corresponds to one of EAN-8, EAN-13, UPC-A and UPC-E and/or each unique identifier has a form compatible with GS1-128.

16. The method of claim 1, wherein each item is an item of perishable goods.

17. (canceled)

18. (canceled)

19. An apparatus comprising at least
one processor; and
at least one memory including computer program code; the at least one memory and the computer program code being configured to, with the at least one processor cause an apparatus to perform:
receiving, from a terminal device via a communications network, a first request for a unique identifier for a first set of one or more items of the same type, wherein the first request comprises information on the first set, the information on the first set comprising at least an identifier for the type of the first set and an expiration date for the first set;
generating a first unique identifier for the first set of one or more items based at least on the identifier for the type of the first set, a first time stamp corresponding to a current time and the expiration date;
storing, by the identifier management system, the first unique identifier to a database; and
transmitting, by the identifier management system, the first unique identifier for the first set to the terminal device via the communications network.

20. The apparatus of claim 19, wherein the apparatus is comprised in an identifier management system.

21. A non-tangible computer-readable storage medium storing one or more instructions which, when executed by one or more processors, cause an apparatus comprising the one or more processors to carry out at least:
generating, in response to the apparatus receiving, from a terminal device via a communications network, a first request for a unique identifier for a first set of one or more items of the same type, wherein the first request comprises information on the first set, the information on the first set comprising at least an identifier for the type of the first set and an expiration date for the first set, a first unique identifier for the first set of one or more items based at least on the identifier for the type of the first set, a first time stamp corresponding to a current time and the expiration date;
storing the first unique identifier to a database; and
causing transmitting the first unique identifier for the first set to the terminal device via the communications network.
